(19) United States
(12) Patent Application Publication
(10) Pub. No.: US 2023/0381669 A1
(43) Pub. Date: Nov. 30, 2023

(54) SYSTEMS, DEVICES, AND METHODS FOR ONLINE CONTESTS

(71) Applicant: Contestee, Inc., Irvine, CA (US)

(72) Inventor: Behzad Yari, Irvine, CA (US)

(21) Appl. No.: 18/031,589

(22) PCT Filed: Oct. 21, 2021
(86) PCT No.: PCT/US2021/056048

§ 371 Date: Apr. 12, 2023

Related U.S. Application Data
(60) Provisional application No. 63/105,076, filed on Oct. 23, 2020.

(51) Int. Cl. A63F 13/80; A63F 13/46; G06Q 50/00; G06Q 30/06

(52) U.S. Cl. CPC A63F 13/80; A63F 13/46; G06Q 50/01; G06Q 30/06

(57) ABSTRACT

A contest system includes a memory and a processor coupled to the memory. The processor operates in accordance with application instructions stored in a computer-readable medium embodied in the memory to enable creation of a contest entry through a user device. The contest entry includes a contest content and associated information comprising one or more specified contests for entry of the contest entry. The processor also operates in accordance with application instructions stored in a computer-readable medium to receive the contest entry from the user device and enter the contest entry in at least one contest based on the one or more specified contests.

### FIELD

The present disclosure relates generally to systems for online contests, and more particularly, to system servers and client devices for enabling online contests.

### BACKGROUND

Contests are an expanding aspect of online activity. Sites exist that provide users the ability to participate in online contests. However, some features that enhance user experience and encourage increased user participation are missing from existing sites.

### SUMMARY

Apparatuses and methods disclosed herein enable online contests through a contest system. The contest system includes server-side components, client-side components, and application modules, which together execute features of online contests including contest participation in a variety of capacities including as a contestant and as a voter.

In one aspect, an apparatus of a contest system includes a memory and a processor coupled to the memory. The processor operates in accordance with application instructions stored in a computer-readable medium embodied in the memory to enable creation of a contest entry through a user device. The contest entry includes a contest content and associated information comprising one or more specified contests for entry of the contest entry. The processor also operates in accordance with application instructions stored in a computer-readable medium to receive the contest entry from the user device and enter the contest entry in at least one contest based on the one or more specified contests.

The contest may be a popularity contest open to all members of the contest system, or it may be a hosted contest open to select users or members of the contest system. In either case, the processor further operates in accordance with application instructions stored in a computer-readable medium to enable access to the contest content of contest entries by each of a plurality of user devices. For example, in the case of a popularity contest, the contest content may be made available to users devices of all members of the contest system for viewing and voting. In the case of a hosted contest, the contest content may be made available to users devices of select users of the system, e.g., talent evaluators or judges, for audition purposes, after which contest entries and their associated contest content that pass audition are made available to users devices of all members of the contest system for viewing and voting.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1A is a block diagram of participants and functionality of an online popularity contest developed and administered by a contest system.

FIG. 1B is a block diagram of participants and functionality of an online hosted contest developed by a third-party and administered by a contest system.

FIG. 2 is an illustration of a contest system including server-side devices, e.g., a server and a database, and client-side devices, e.g., user devices.

FIG. 3A is a flowchart of a method of administering a popularity contest.

FIG. 3B is a flowchart of a method of administering a hosted contest

FIG. 4 is a flowchart of a method of creating and submitting a contest entry.

FIG. 5 is a flowchart of a method of member status administration.

FIG. 6 is a block diagram of an server-side apparatus configured to enable online contests.

FIG. 7 is a block diagram of a client-side apparatus configured to enable online contests.

FIGS. 8A-8E are illustrations of user devices displaying various pages of the contest system application.

### DETAILED DESCRIPTION

The detailed description set forth below together with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

Disclosed herein is a contest system, and associated software applications, which enables user participation in online contests, such as talent contests, beauty contests, athletic contests, etc. To use the contest system and the numerous benefits and features it provides, a user creates an account with the contest system by accessing an application using a user device, e.g., a mobile telephone, computer or any smart device, and registers with the system. Once an account is created the user becomes a member of the contest system. Accordingly, “user” and “member” are used interchangeably going forward.

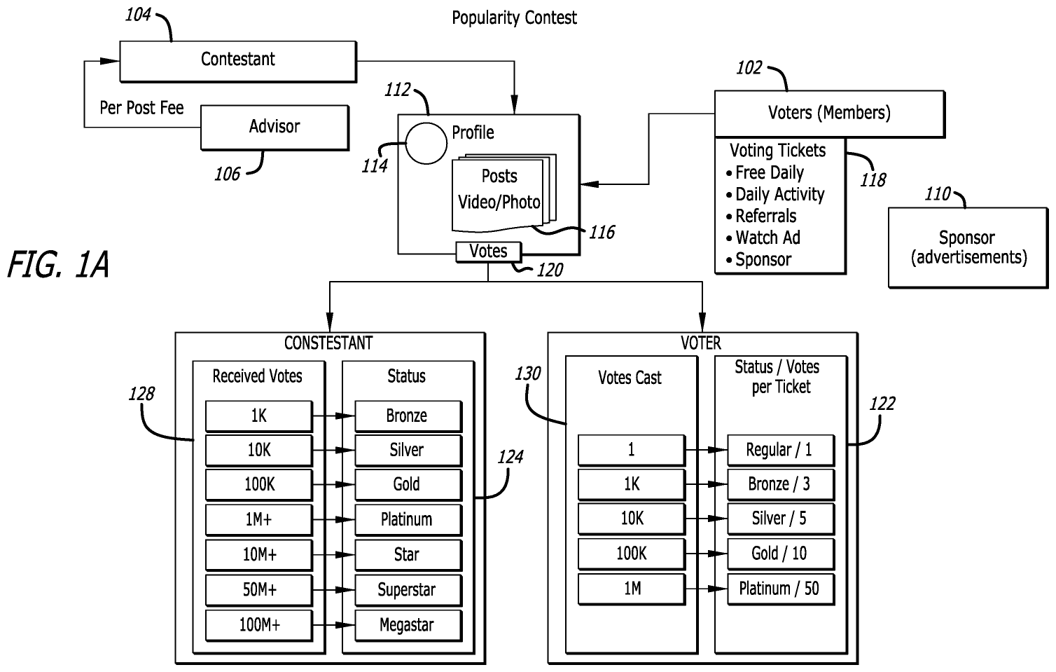

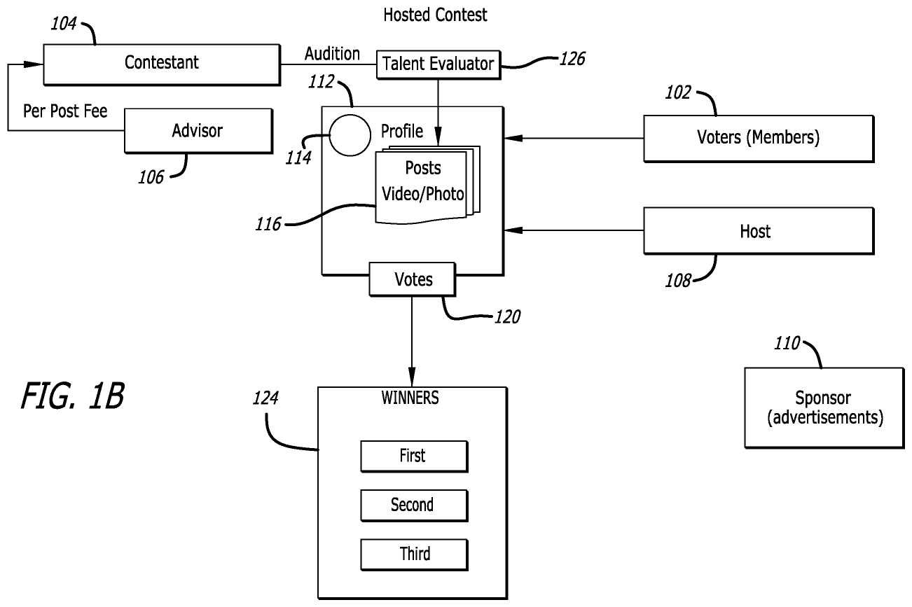

With reference to FIGS. 1A and 1B, users or members of the contest system may participate in online contests in one or more capacities. A member may participate as a voter 102, a contestant 104, an advisor 106, a contest host 108, and a sponsor 110. In a typical use case of the contest system, by default a member is registered by the system as a voter 102. As a voter 102, a member is able to access and play contest entries 112, also referred to as contest posts, submitted by contestants 104 of the system, and to cast votes for contestants. A contest entry 112 may include visual content, e.g., still pictures, videos, etc. or auditory content, e.g., sound recording, or audio/visual content. As used herein, “playing” contest content or contest posts may include for example, streaming a video, viewing a still picture, or listening to a sound recording.

Once registered, a member may become a contestant 104. A member becomes a contestant 104 by submitting a contest entry 112 that includes a profile 114 of the contestant and a contest post 116, e.g., a picture, a video, a sound recording, etc. The contest post 116 is alternatively referred to herein as contest content. Upon receipt of a contest entry 112, the contest system processes the contest entry, enters the contest entry in one or more specified contests, and presents, makes available, or enables access to the contest entry 112 by voters 102 through user devices that are logged into an account of the contest system under the credentials of a member or guest of the contest system.

An advisor 106 is an expert in a particular domain, e.g., music, sing, dance, etc., of the contest system. Contestants 104 may retain an advisor 106 to review the contest entries 112 of the contestant.

Contests available through the contest system may be developed by the contest system itself. For example, the contest system may administer predefined specified contests. These contests may be referred to as “popularity contests.” Contests administered through the contest system may also be developed and hosted by a third party on the contest system platform. These contests may be referred to as “hosted contests.”

With reference to FIG. 1A, for popularity contests administered by the contest system, the contest system monitors the number of votes 120 given or cast by voters 102 overtime, and the number of votes received by or cast for a contestant's contest entries over time and assigns status levels to each contest entry. For voters 102, regular, bronze, silver, gold, and platinum status levels 122 are reached upon the casting of different threshold levels 130 of votes by the voter. For contestants 104, bronze, silver, gold, platinum, star, superstar, and megastar levels 124 are reached upon receipt of different threshold levels 128 of votes by the contestant.

With reference to FIG. 1B, a third-party contest host 108 may use the contest system to run a hosted contest that is either open to all members of the contest system or to a targeted group of members. A contest host 108 may be, for example, a celebrity, an influencer, a company, or a school. In one example scenario, a third-party organization sends a request to the contest system to a host a contest. The contest system creates a stage for the organization with all of the tools the organization needs to run a contest. The contest host 108 may announce the contest through, for example, a social media post announcing a best piano player contest having an entry fee of $100, a prize of $5000, an entry deadline, and minimum/maximum number of entries.

Contestants enter the third-party organization's stage and submit contest entries. In one configuration, the contest system may implement—on behalf of the contest host 108—audition process, where contestant entries are initially evaluated/screened by a talent evaluator 126 in order to make it into the hosted contest. In another configuration (not shown in FIG. 1B), the contest system may implement—on behalf of the contest host 108—a preliminary or qualifying contest where contestant entries are evaluated/screened and voted on by the host 108 or guest judges in order to advance through the hosted contest. The contest system may then implement—on behalf of the contest host 108—a contest for those contest entries 112 that survive the qualifying contest. These contest entries are made available by the contest system for evaluation/screening and voting on by all members 102 of the contest system. The contest system monitors the number of votes 120 given or cast by voters 102 overtime, and determines contest winners 132.

In either contest type, e.g., popularity contest (FIG. 1A) or hosted contest (FIG. 1B), a sponsor 110 may use the contest system to advertise its goods or services to members. Voters 102 may be compensated for playing sponsor advertisements in the form of voting tickets 118 that allow the member to cast votes in the contest system. Sponsor advertisements may be targeted to members of the contest system based on member profiles and member activity. Sponsors 110 may also benefit from participation in the contest system through discovery of talent relevant to the sponsor's business. For example, a fashion magazine may discovery a contestant of beauty contest that matches a desired appearance for a photo shoot.

Having thus provided a general description of the contest system, its participants, operation, and its benefits and features, a more detailed system overview is provided below.

### Contest System Architecture

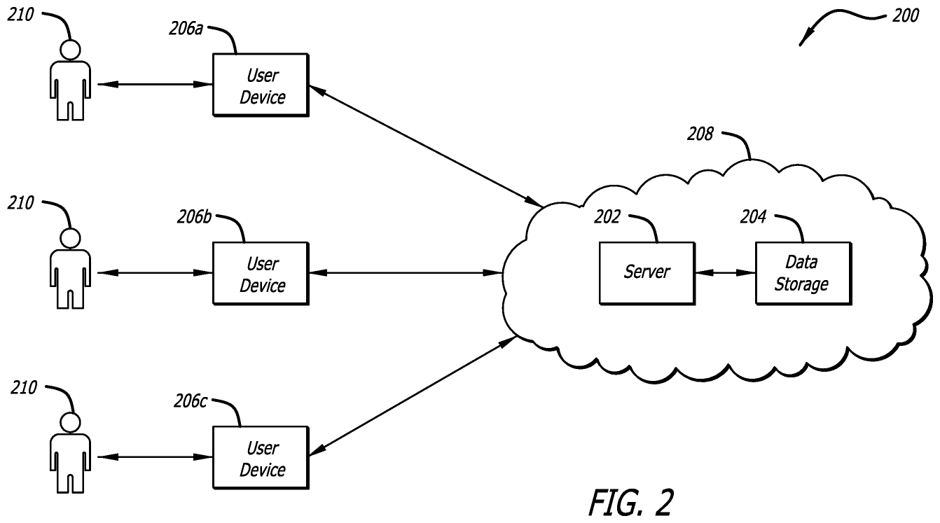

With reference to FIG. 2, a contest system 200 as generally described above includes server-side devices 202, 204, client-side (or user-side) devices 206a, 206b, 206c and one or more software applications accessible by the respective devices that enable the functionality and features of the contest system. For illustrative purposes, the server-side devices include one or more servers 202 and one or more data storage structures or databases 204. The client-side devices 206a, 206b, 206c may include mobile telephones, desktop computers, laptop computers, or tablet computers or any smart devices. Throughout this disclosure, server-side devices that perform a serving function may be referred to as “server devices” or “servers,” while those that perform a data storage function may be referred to as “data stores” or “databases.” Client-side devices 206a, 206b, 206c may be referred to as “client devices” or “user devices.”

Server-side devices 202, 204 may be co-located (e.g., within the same network and/or physical location) or distributed (e.g., within a different network and/or physical location) in relation to each other. For example, one or more of the server-side devices may be associated with an Internet-based (e.g., “cloud”-based) computing environment.

Communications between the user devices 206a, 206b, 206c and the server-side devices 202, 204 may be performed by respective device network interfaces that enable wired connections and/or wireless connections. For example, communication between the server-side devices 202, 204 and the user devices 206a, 206b, 206c may be based on standard client/server Internet architecture involving Transmission Control Protocol/Internet Protocol (TCP/IP) and Hypertext Transfer Protocol (HTTP) requests. Alternatively, the server-side devices 202, 204 may communicate with a user device 206a, 206b, 206c via a local area network (LAN) that utilizes a wireless access point (AP) or by via a cellular network that utilizes one or more access nodes. The LAN may implement protocols and/or algorithms that comply with various communication standards of the Institute of Electrical and Electronics Engineers (IEEE), such as IEEE 802.11. The cellular network may implement several types of technologies without deviating from the scope of the present disclosure. For example, the cellular network may implement protocols and/or algorithms that comply with various communication standards of the Third Generation Partnership Project (3GPP) and 3GPP2, such as 3G and 4G (Long Term Evolution), and of the Next Generation Mobile Networks (NGMN) Alliance, such as 5G.

### User Registration

Continuing with reference to FIG. 2, as described above, a user 210 may register with the contest system 200 by accessing a software application of the system via a browser or an application on a user device 206a, e.g., mobile telephone, computer, or smart device, and entering information to create a user profile. The information entered includes login credentials, e.g., a user defined username and password. Personal information, such as the full name of the user, and one or more types of correspondence information, including for example, the user's email address may be required to be entered. The entered information is then transmitted by the user device 206a to a server 202, where the information is processed and recorded in a database 204 as a member profile.

As previously described, a member may participate in the contest system as a voter that casts votes in contests administered by the contest system, a contestant that submits contest entries, or both a voter and contestant. During the registration process, the user 210 becomes automatically registered as a voter, and may optionally submit one or more contest entries to become a contestant. A member may also register as a talent advisor that is an expert in a particular domain, e.g., music, sing, dance, etc., of the contest system.

Contestant members may retain a talent advisor to review contest entries. A talent advisor may set a fee. A contestant selects advisor and pays the fee. The talent advisor gets notice of the payment and accesses the contestant profile through the contests system and plays the contest content. The talent advisor may post a review in the contestant's profile in the contest system. The contestant has the option of posting the review on social media.

### Popularity Contest Administration

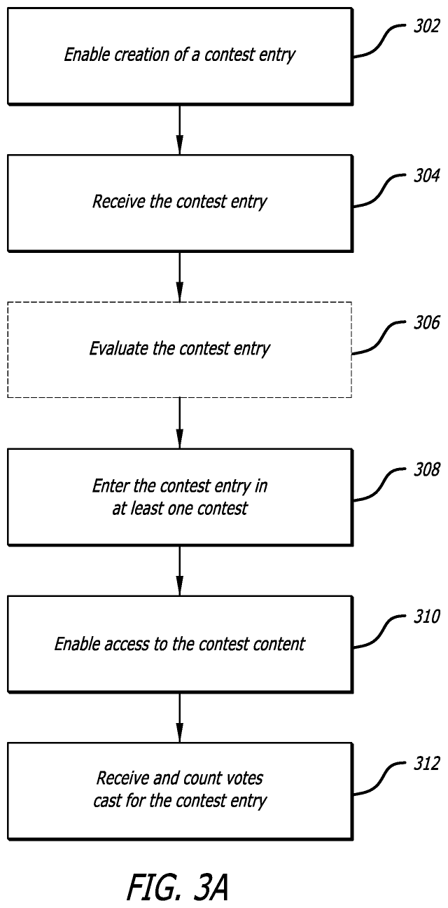

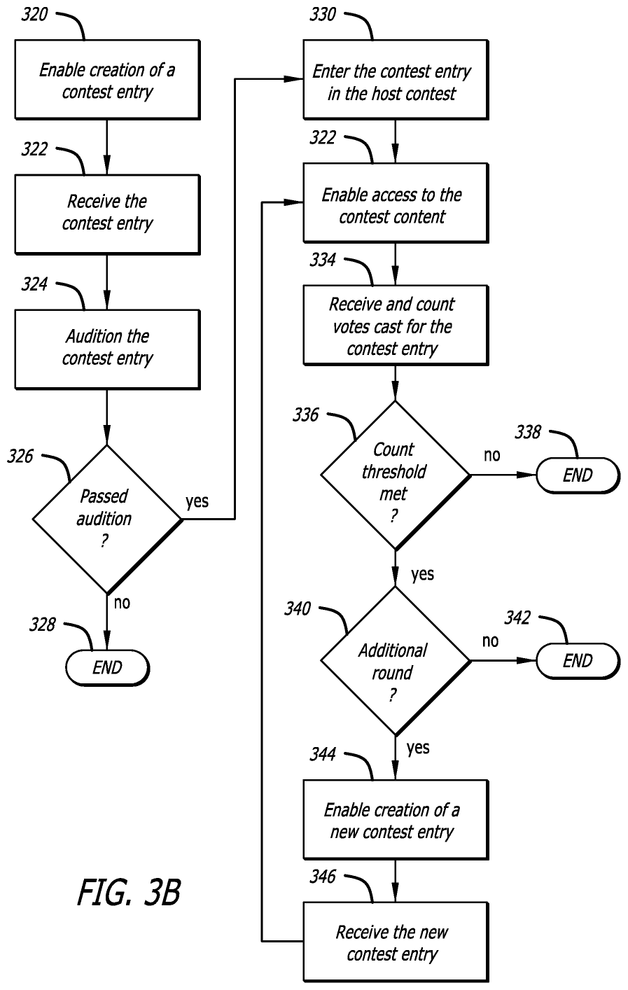

FIG. 3A is a flowchart of a method of popularity contest administration. The contest may be a popularity contest in which any member of a contest system may enter. The method may be implemented by an apparatus, e.g., a server 202, of the contest system 200 of FIG. 2 operating in accordance with application instructions stored in a computer-readable medium.

At block 302, the server 202 enables a creation of a contest entry through a user device 206a. The contest entry includes a contest content and associated information. Contest content may be visual content, e.g., a picture, a video, etc. or auditory content, e.g., a sound recording, or audio/visual content, e.g., a music video. The associated information includes one or more specified contests for entry of the contest entry. Specified contests may include contests directed to anyone of a number of general categories. General categories of contests may include, for example, music, song, dance, visual art, beauty, comedy, etc. Specified contests may further include contests directed to anyone of a number of sub-categories of a general category. For example, within the general category of music, contests may be directed to different instruments, e.g., piano, guitar, etc. or to different genera, e.g., classical, jazz, rock, etc. As described later below, specified contests may be selected by a contestant from a list of available, active contests within the contest system.

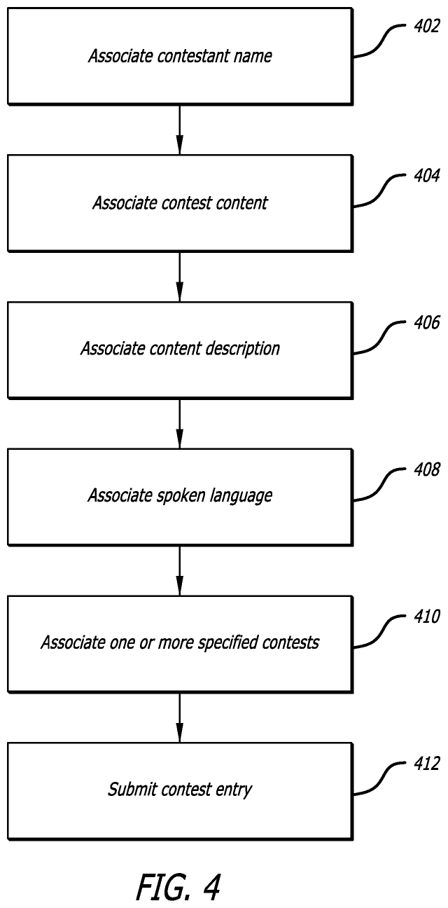

The associated information of a contest entry may also include one or more characterizations of a type of contest content in the form of hash tags, and one or more languages of the contest content. Hash tags may be used, for example, to indicate the type or format of the contest content, e.g., video, picture, etc. Language information identifies the language or languages present in the contest content. Details of a method of creating a contest entry by a user device are described later below with reference to FIG. 4.

Continuing with FIG. 3A, at block 304, the server 202 receives the contest entry from a user device 206a. At block 306, the server 202 may submit the contest entry for evaluation to determine the accuracy of the associated information, e.g., the type of contest content, the language of the content, the status and/or existence of the specified contests. To this end, the server 202 may submit the contest entry for evaluation by a talent evaluator. The talent evaluator may be a person or a computer processor with artificial intelligence (AI) capabilities.

The talent evaluator or AI processor checks the relevancy and accuracy of the information associated with the contest entry, including the specified contests, the content hash tags, and the indicated languages. If all of the associated information is valid and accurate the contest entry is approved by the talent evaluator or AI processor. If some of the associated information is determined to be invalid or inaccurate, the contest entry is rejected. For example, a contest entry will be rejected when its associated information includes a specified contest corresponding to a piano playing contest, but the contest content has no piano playing in it.

At block 308, if the contest entry is approved, the server 202 may enter the contest entry in a contest based on the one or more specified contests associated with the contest entry. The contest in which the contest entry is entered may correspond to one of the specified contests. For example, an approved contest entry that specifies a piano playing contest may be entered into a piano playing contest. As a unique feature of the contest system 200 disclosed herein, a single contest entry may be entered into multiple contests. For example, a contest entry having a video of a female artist playing the piano and singing a song may be associated with a singing contest, a piano player contest, and a beauty contest.

The server 202 creates a contestant profile for each specified contest that is entered, and makes the contest content available for members to experience and vote on. Continuing with the example of a contest entry of a female playing piano and singing, the server 202 creates a contestant profile for each of the piano playing contest, the singing contest and the beauty contest.

In some cases, however, a specified contest may not yet exist because not enough entries for the specified contest have been received. To address this situation, for each of the one or more specified contests associated with a contest entry, the server 202 determines a total number of contests entries received by the contest system 200 that have the specified contest associated therewith, and compares the total number to a respective threshold for the specified contest. For example, a specified contest may require a threshold of at least ten entries before the contest commences. In response to the respective threshold being satisfied, the server 202 enters the contest entry in the specified contest. In response to the respective threshold not being satisfied, the server 202 may enter the contest entry in a general-category contest or generic contest of the specified contest. For example, a contest entry that includes a piano playing contest as a specified contest may be temporarily placed in a musical instrument contest until enough piano playing contest entries are received.

In cases where the contest entry is placed in a generic contest due to insufficient contest entries, the server 202 monitors the total number of contest entries received by the contest system 200 that have the specified contest in its associated information, and compares the number to the respective threshold for the specified contest. When the total number of contest entries for the specified contest satisfy the respective threshold, the server 202 initiates the specified contest among those contest entries. In one configuration, the contest entry continues to participate in the generic contest after initiation of the specified contest. Thus, in the example of piano playing content, the contest entry would participate in both a newly initiated piano playing contest, and the generic musical instrument contest.

At block 310, the server 202 enables access to the contest content by each of a plurality of user devices 206b, 206c logged into the contest system 200 under the credentials of a member (or guest). To this end, the server 202 may enable through the GUI of the user device 206b, 206c, a display of the contestant profile associated with the contest entry and a playing e.g., viewing or listening, of the contest content. Enable a display and playing means, for example, the server 202 transmit or provides data or information that displays a contestant profile on GUI of a user device, together with a mechanism, e.g., select button, on the display, which upon activation at the user device, initiates a transmission of the contest content from the server to the user device.

At block 312, the server 202 receives votes casted for the contest entry by members of the contest system 200 from the user devices 206b, 206c through which the member is logged into the contest system. The server 202 counts the votes. As part of counting votes, the server 202 is further configured to associate a status level with the contest entry, and thereby the contestant, based on a count of votes received for the contest entry. With reference to Table 1 below, in one configuration the server 202 defines a number of different contestant status levels and corresponding threshold vote counts needed to attain that status.

TABLE 1

| Vote count | Contestant Status Level |
|---|---|
| 1,000 | Bronze |
| 10,000 | Silver |
| 100,000 | Gold |

| | | |
|---|---|---|
| 1 | million | Platinum |
| 10 | million | Star |
| 50 | million | Superstar |
| 100 | million | Megastar |

The server 202 may be further configured to monitor the status level of the contest entry and the status level of each of the contest entries in the specified contest, and create one or more status-level contests based on the respective status levels. To this end, after a certain period of time allowed by the contest system 200 for a specified contest, the server 202 may group together all contest entries for that specified contest that obtained “Star” status level and initiate a new “Star Level” contest for those contest entries. Similarly, the server 202 may group together all contest entries that obtained “Superstar” status level and initiate a new “Superstar Level” contest for those contest entries. Similarly, the server 202 may group together all contest entries that obtained “Megastar” status level and initiate a new “Megastar Level” contest for those contest entries. The contest system 200 may provide prizes to contest winners, and the value of prize may be commensurate with the level of competition, meaning a Superstar Level contest will have a prize of greater value than a Star Level contest, while a Megastar Level will have a prize of greater value than a Superstar Level contest.

### Hosted Contest Administration

FIG. 3B is a flowchart of a method of hosted contest administration. The contest may be a hosted contest in which in which any member of a contest system may enter or it may be limited to select members of the contest system. The method may be implemented by an apparatus, e.g., a server 202, of the contest system 200 of FIG. 2 operating in accordance with application instructions stored in a computer-readable medium.

At block 320, the server 202 enables a creation of a contest entry through a user device 206a currently logged into the contest system 200 under the credentials of a permitted contestant of the hosted contest. A permitted contestant may be any member of the contest system or a select member of the contest system. The contest entry includes a contest content and associated information. Contest content may be visual content, e.g., a picture, a video, etc. or auditory content, e.g., a sound recording, or audio/visual content, e.g., a music video. The associated information may include a contestant profile, e.g., name, photograph, etc., and information on the hosted contest in which the contest entry is to be entered.

The associated information of a contest entry may also include one or more characterizations of a type of contest content in the form of hash tags, and one or more languages of the contest content. Hash tags may be used, for example, to indicate the type or format of the contest content, e.g., video, picture, etc. Language information identifies the language or languages present in the contest content. Details of a method of creating a contest entry by a user device are described later below with reference to FIG. 4.

Continuing with FIG. 3B, at block 322, the server 202 receives the contest entry from the user device 206a.

At block 324, the server 202 submits the contest entry for an audition to determine the quality of the contest content. To this end, the server 202 may submit the contest entry for initial evaluation by the contest host and/or one or more judges. To this end, the server 202 may send a notification of the contest entry for audition to a user device 206b, 206c associated with the contest host and/or one or more judges. The server 202 enables access to the contest content by a user device 206b, 206c logged into the contest system 200 under the credentials of the contest host and/or one or more judges.

At block 326, the server 202 determines whether the contest entry passed the audition. To this end, the server 202 may receive a notification from a user device 206b, 206c logged into the contest system 200 under the credentials of the contest host and/or one or more judges indicating that the contest entry passed the audition. If the contest entry did not pass the audition, the process proceeds to block 328 and ends.

Returning to block 326, if the contest entry did pass the audition, the process proceeds to block 330 and the server 202 enters the contest entry in the hosted contest. To this end, the server 202 creates a contestant profile for the hosted contest, and makes the contest content available for members of the contest system 200 to experience and vote on. In some embodiments, the hosted contest is a multi-round contest in which the contest entry, together with other submitted contest entries, may be voted on.

At block 332, the server 202 enables access to the contest content by each of a plurality of user devices 206b, 206c currently logged into the contest system 200 under the credentials of a member (or a guest). To this end, the server 202 may enable through the GUI of the user device 206b, 206c a display of the contestant profile associated with the contest entry and a playing e.g., viewing or listening, of the contest content. Enable a display and playing means, for example, the server 202 transmit or provides data or information that displays a contestant profile on GUI of a user device 206b, 206c together with a mechanism, e.g., select button, on the display, which upon activation at the user device, initiates a transmission of the contest content from the server to the user device.

At block 334, the server 202 receives votes casted for the contest entry during a specified period of time. The votes are received from user devices 206b, 206c through which members are logged into the contest system 200. The server 202 counts the votes.

At block 336, the server 202 determines if the vote count for the contest entry satisfied a count threshold. For example, the server 202 may implement contest rules defined by the contest host that specify contest winning and/or advancement either in terms of a threshold number of votes or a threshold placement, e.g., first, top five, top ten, etc., that a contest entry must have in order to win the contest or advance to the next round (in the case of a multi-round hosted contest). If the vote count for the contest entry fails to satisfy, e.g., meet to exceed, the count threshold, the process proceeds to block 338, where the contest ends for the contest entry.

Returning to block 336, if the contest entry does meet or exceed the count threshold, the process proceeds to block 340, where the server 202 determines if there is an additional round to the hosted contest. As previously mentioned, the hosted contest may be a multi-round contest. If there is no additional round to the contest, the process proceeds to block 342 and ends.

At this stage, the contest entry may be declared the winner of the hosted contest. The server 202 may submit the winning contest entry for further advancement in the contest system 100 by the contest host and/or one or more judges. To this end, the server 202 may send a notification of the winning contest entry to a user device 206b, 206c associated with the contest host and/or one or more judges. The notification may invite the host and/or one or more judges to designate the winning contest entry as a “star” or “superstar.” If the winning contest entry is so designated by the host and/or one or more judges, the server 202 then enables access to the contest content by each of a plurality of user devices 206b, 206c currently logged into the contest system 200 under the credentials of a member (or a guest) for further evaluation and voting by all members of the contest system. To this end, the server 202 may enable through the GUI of the user device 206b, 206c a display of the winning contestant profile and a playing e.g., viewing or listening, of the winning contest content. As previously described, enable a display and playing means, for example, the server 202 transmit or provides data or information that displays a contestant profile on GUI of a user device 206b, 206c together with a mechanism, e.g., select button, on the display, which upon activation at the user device, initiates a transmission of the contest content from the server to the user device

Returning to block 340, if there is an additional round to the contest, the process proceeds to block 344 where the server 202 enables the creation of a new contest entry. To this end, the server 202 sends a notification of such advancement to a user device 206a associated with the contestant that submitted the contest entry. The notification invites the contestant to submit new contest content for the next round of the contest. To this end, and similar to described above with respect to block 320, the server 202 enables the uploading of new contest content through a user device 206a currently logged into the contest system 200 under the credentials of contestant.

At block 346, the server 202 receives the new contest content and the process returns to block 332, where the server 202 administers the next round of the multi-round hosted contest with respect to the new contest content. This process is repeated until the multi-round contest ends at block 342.

### Contest Entry Creation

FIG. 4 is a flowchart of a method of creating and submitting a contest entry. The method may be performed by a user device 206a of the contest system 200 of FIG. 2. In a session enabled by the contest system 200, a user 210 may access the contest system application on a user device 206a and submit a contest entry. To enable a contest entry, the user device 206a operating in accordance with the system application, presents a graphical user interface (GUI) on the display of the device that allows for the creation and submission of a contest entry as follows:

At block 402, a contestant name is associated with the contest entry by enabling the entry of the name into the GUI. The contestant name may be the name of the user 210 or another person or thing. For example, the contestant name may be the user's child or pet.

At block 404, contest content is associated with the contest entry by enabling the selection of available content for upload. Contest content may also be referred to as talent demonstration. The contest content may be located in memory of the user device and may be visual content, e.g., a picture, a videos, etc. or auditory content, e.g., a sound recording, or audio/visual content, e.g., a music video.

At block 406, hash tags may be associated with the entry by enabling the entry of hash tags into the GUI of the user device. The hash tags may describe the content itself, e.g., #video, #food, #guitar, and provide a mechanism for contest system members to search for specific types of contest entries they are interested in.

At block 408, one or more spoken languages may be associated with the entry by enabling the entry of spoken languages through the GUI of the user device. For example, languages may be listed in and selected from a pull down menu made available through the GUI of the user device by the system server.

At block 410, the contest entry is associated with at least one specified contest in the contest system. For example, specified contests may be listed in and selected from a pull down menu made available through the GUI of the user device 206a by the server 202. Specified contests may include contests directed to specific musical instruments, or specific genera of music, or specific people. As previously mentioned, a contest entry may be associated with multiple contests. For example, a video of a person playing the piano and singing a song may be associated with a singing contest, a piano player contest, and a beauty contest.

At block 412, the contest entry is submitted by enabling an activation of a submission button through the user device, which in turn causes the user device to transit the contest entry and its associated information to the contest system server.

### Member Voter and Contestant Status

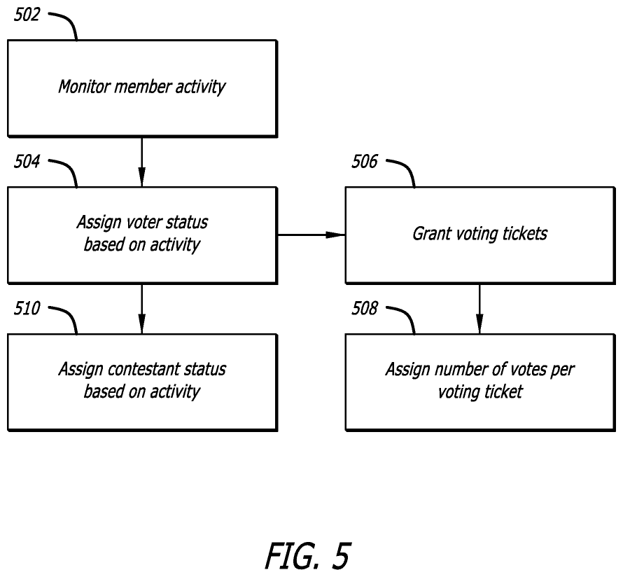

FIG. 5 is a flowchart of a method of member status administration. The method may be implemented by an apparatus, e.g., a server 202, of the contest system 200 of FIG. 2 operating in accordance with application instructions stored in a computer-readable medium.

At block 502, the server 202 monitors activity of a member of the contest system 200. Member activity may be related to voting features of the system, and may include, for example, the number of votes given or cast by the member. Member activity may also be related to contestant features of the system, and may include, for example, the number of votes received by the member.

At block 504, the server 202 assigns a voter status to the member based on the monitored member activity. To this end, the server 202 keeps track of the number of votes cast by the member and associates a voter status level with the member based on the number. With reference to Table 2 below, in one configuration the server 202 defines a number of different voter status levels and corresponding threshold vote counts needed to attain that status.

TABLE 2

| Vote count | Voter Status Level |
|---|---|
| 1 | Regular |
| 1,000 | Bronze |
| 10,000 | Silver |
| 100,000 | Gold |
| 1,000,000 | Platinum |

At block 506, the server 202 grants voting tickets to the member based on member activity. Voting tickets, which are required in order for a member to be able to cast votes, may be granted to a member based on: 1) the number of sponsor advertisements played by the member, 2) the number of contest entries played by the member, 3) purchases of voting tickets by the member, 4) previous votes cast by the member, 5) contest participation history of the member, and 6) referral of another member.

In one configuration, the server 202 grants a member ten voting tickets for free every time the member logs into the contest system. In another configuration, the server grants voting tickets to a member based on the member's prior day activity on the contest system. For example, the server 202 may count the number of contest videos the member watched on one day, and based on that count, grant a certain number of voting tickets to the member the following day or the next time the member logs into the contests system.

In another configuration, the server 202 grants voting tickets by referral. In this case, if a current member refers a potential new member to the contest system, and the potential new member visits the contest system site and confirms the referring current member is a friend—then the referring current member is granted one or more voting tickets. In another configuration, the server 202 counts the number of sponsor advertisements the member watches and grants a certain number of voting tickets to the member for free based on the count.

At block 508, the server 202 assigns a number of votes per voting ticket based on the voter status of the member. With reference to Table 3 below, in one configuration the server 202 defines a number of different number of votes per vote ticket based on voter status levels.

TABLE 3

| Voter Status Level | Vote per vote ticket |
|---|---|
| Regular | 1 |
| Bronze | 3 |
| Silver | 5 |
| Gold | 10 |
| Platinum | 50 |

At block 510, the server 202 assigns a contestant status to the member based on member activity. To this end, and as previously described with reference to Table 1, the server 202 compares a total number of votes received by the member against a plurality of threshold numbers, and determines the contestant status of the member based on a comparison outcome.

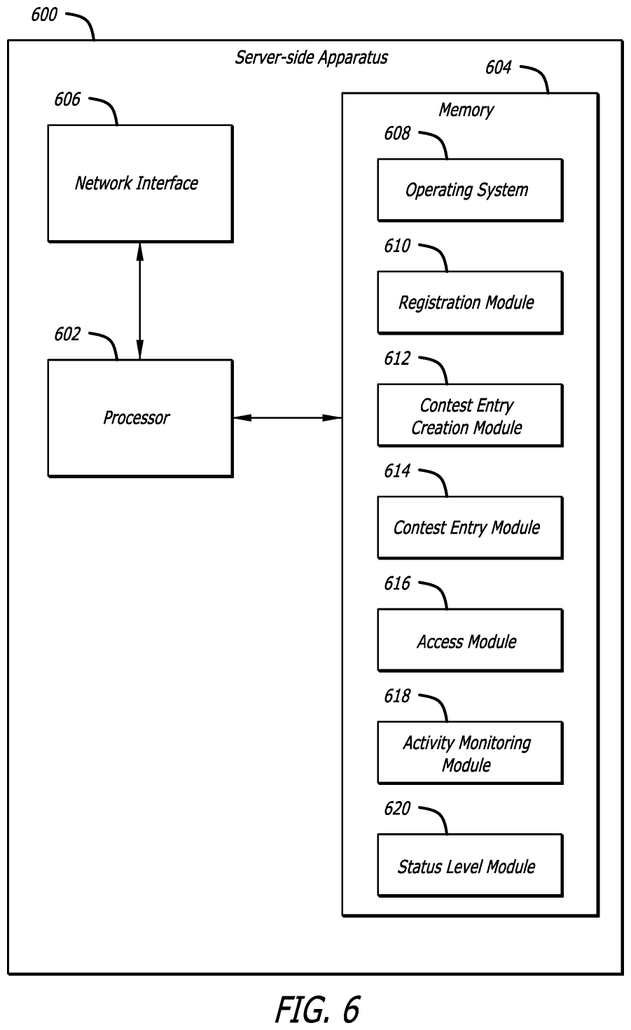

FIG. 6 is a schematic block diagram of a server-side apparatus 600, e.g., contest system server, configured to enable one or more of the contest system functionalities describe above with reference to FIGS. 1A-5. The apparatus 600 may be embodied in any number of processor-driven devices, including, but not limited to, a server computer, a personal computer, one or more networked computing devices, an application-specific circuit, a minicomputer, a microcontroller, and/or any other processor-based device and/or combination of devices.

The apparatus 600 may include one or more processors 602 configured to access and execute computer-executable instructions stored in at least one memory 604. The processor 602 may be implemented as appropriate in hardware, software, firmware, or combinations thereof. Software or firmware implementations of the processor 602 may include computer-executable or machine-executable instructions written in any suitable programming language to perform the various functions described herein. The processor 602 may include, but is not limited to, a central processing unit (CPU), a digital signal processor (DSP), a reduced instruction set computer (RISC) processor, a complex instruction set computer (CISC) processor, a microprocessor, a microcontroller, a field programmable gate array (FPGA), a System-on-a-Chip (SOC), or any combination thereof. The apparatus 600 may also include a chipset (not shown) for controlling communications between the processor 602 and one or more other components of the apparatus 600. The processor 602 may also include one or more application-specific integrated circuits (ASICs) or application-specific standard products (ASSPs) for managing specific data processing functions, tasks, and execution of machine-readable code.

The memory 604 may include, but is not limited to, random access memory (RAM), flash RAM, magnetic media storage, optical media storage, and so forth. The memory 604 may include volatile memory configured to store information when supplied with power and/or non-volatile memory configured to store information even when not supplied with power. The memory 604 may store various program modules, application programs, and so forth that may include computer-executable instructions that upon execution by the processor 602 may cause various operations to be performed. The memory 604 may further store a variety of data manipulated and/or generated during execution of computer-executable instructions by the processor 602.

The apparatus 600 may further include one or more network interfaces 606 that may facilitate communication between the apparatus and one or more other contest system components, e.g., client-side devices, using any suitable communications standard including any of those previously described. For example, communication may be based on standard client/server Internet architecture involving Transmission Control Protocol/Internet Protocol (TCP/IP) and Hypertext Transfer Protocol (HTTP) requests. Alternatively, communication may be based on a LAN interface that implement protocols and/or algorithms that comply with various communication standards of the Institute of Electrical and Electronics Engineers (IEEE), such as IEEE 802.11, while a cellular network interface implement protocols and/or algorithms that comply with various communication standards of the Third Generation Partnership Project (3GPP) and 3GPP2, such as 3G and 4G (Long Term Evolution), and of the Next Generation Mobile Networks (NGMN) Alliance, such as 5G.

Continuing with the memory 604, an operating system 608 may be loaded therein that may be configured to manage hardware, software and/or firmware resources and provide numerous services to applications executing on the apparatus 600. The memory 604 may further include various program modules such as a registration module 610, a contest entry creation module 612, a contest entry module 614, an access module 616, an activity monitoring module, and a status level module 620, each of which includes functions in the form of logic and rules that respectively support and enable the contest system functions described above with reference to FIGS. 1A-5. Although illustrated as separate modules in FIG. 6, one or more of the modules may be a part of or a submodule of another module.

The registration module 610 is configured to enable a user to register with the contest system through a user interface of a user device. The contest entry creation module 612 is configured to enable creation of a contest entry through a user device, where the contest entry includes a contest content and associated information comprising one or more specified contests for entry of the contest entry. The network interface 606 is configured to receive the contest entry from a user device. The contest entry module 614 is configured to enter the contest entry in at least one contest based on the one or more specified contests. The access module 616 is configured to enable access to the contest content by each of a plurality of user devices. The activity monitoring module 618 is configured to monitor member activity of a member of the contest system. The status level module 620 is configured to assign at least one of a voter status and a contestant status to the member based on member activity. Details of the operation of these modules are found throughout this disclosure, including in the description of the flowcharts of FIGS. 3A, 3B, and 5, and in the claims below.

The apparatus 600 and modules 610, 612, 614, 616, 618, 620 disclosed herein may be implemented in hardware or software that is executed on a hardware platform. The hardware or hardware platform may be a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a smart card, a flash memory device (e.g., card, stick, key drive), random access memory (RAM), read only memory (ROM), programmable ROM (PROM), erasable PROM (EPROM), electrically erasable PROM (EEPROM), a general register, or any other suitable non-transitory medium for storing software.

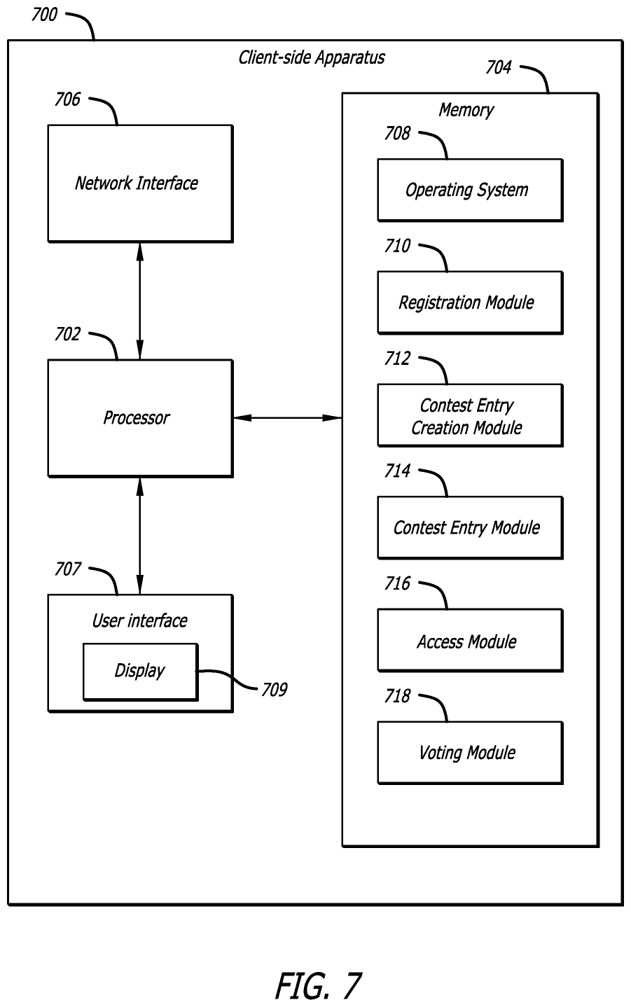

FIG. 7 is a schematic block diagram of a client-side apparatus 700, e.g., user device, configured to enable one or more of the contest system functionalities describe above with reference to FIGS. 1A-5. The apparatus 700 may be embodied in any number of processor-driven devices, including, but not limited to, a mobile device, a smart device, a personal computer, one or more networked computing devices, an application-specific circuit, a minicomputer, a microcontroller, and/or any other processor-based device and/or combination of devices.

The apparatus 700 may include one or more processors 702 configured to access and execute computer-executable instructions stored in at least one memory 704. The processor 702 may be implemented as appropriate in hardware, software, firmware, or combinations thereof. Software or firmware implementations of the processor 702 may include computer-executable or machine-executable instructions written in any suitable programming language to perform the various functions described herein. The processor 702 may include, but is not limited to, a central processing unit (CPU), a digital signal processor (DSP), a reduced instruction set computer (RISC) processor, a complex instruction set computer (CISC) processor, a microprocessor, a microcontroller, a field programmable gate array (FPGA), a System-on-a-Chip (SOC), or any combination thereof. The apparatus 700 may also include a chipset (not shown) for controlling communications between the processor 702 and one or more other components of the apparatus 700. The processor 702 may also include one or more application-specific integrated circuits (ASICs) or application-specific standard products (ASSPs) for managing specific data processing functions, tasks, and execution of machine-readable code.

The memory 704 may include, but is not limited to, random access memory (RAM), flash RAM, magnetic media storage, optical media storage, and so forth. The memory 704 may include volatile memory configured to store information when supplied with power and/or non-volatile memory configured to store information even when not supplied with power. The memory 704 may store various program modules, application programs, and so forth that may include computer-executable instructions that upon execution by the processor 702 may cause various operations to be performed. The memory 704 may further store a variety of data manipulated and/or generated during execution of computer-executable instructions by the processor 702.

The apparatus 700 may further include one or more network interfaces 706 that may facilitate communication between the apparatus and one or more other contest system components, e.g., client-side devices, using any suitable communications standard including any of those previously described. For example, communication may be based on standard client/server Internet architecture involving Transmission Control Protocol/Internet Protocol (TCP/IP) and Hypertext Transfer Protocol (HTTP) requests. Alternatively, communication may be based on a LAN interface that implement protocols and/or algorithms that comply with various communication standards of the Institute of Electrical and Electronics Engineers (IEEE), such as IEEE 802.11, while a cellular network interface implement protocols and/or algorithms that comply with various communication standards of the Third Generation Partnership Project (3GPP) and 3GPP2, such as 3G and 4G (Long Term Evolution), and of the Next Generation Mobile Networks (NGMN) Alliance, such as 5G.

The apparatus 700 may further include one or more user interfaces 707 that may facilitate interaction between a user and the apparatus using one or more input/output (I/O) devices. The I/O devices may include, but are not limited to, a remote control, a display 709, a keypad, a mouse, a pointing device, a control panel, a touch screen display, a microphone, a speaker, and so forth. More specifically, the user interfaces 707 may include hardware, firmware, and/or software for receiving input from a user and providing output to a user via one or more I/O devices. The user interfaces 707 may support one or more displays 709 configured to render and output information to a user.

Continuing with the memory 704, an operating system 708 may be loaded therein that may be configured to manage hardware, software and/or firmware resources and provide numerous services to applications executing on the apparatus 700. The memory 704 may further include various program modules such as a registration module 710, a contest entry creation module 712, a contest entry module 714, an access module 716, a voting module 720, each of which includes functions in the form of logic and rules that respectively support and enable the contest system functions described above with reference to FIGS. 1A-5. Although illustrated as separate modules in FIG. 7, one or more of the modules may be a part of or a submodule of another module.

The registration module 710 is configured to enable a user to register with the contest system through a user interface of the apparatus 700. The contest entry creation module 712 is configured to enable creation of a contest entry through the apparatus 700, where the contest entry includes a contest content and associated information comprising one or more specified contests for entry of the contest entry. The contest entry module 714 is configured to enable a user to enter the contest entry in at least one contest based on the one or more specified contests. The access module 716 is configured to enable a user to access contest content through the user interface 707 of the apparatus 700. The voting module 718 is configured to enable the user to acquire voting tickets and to cast votes for a contest entry through the user interface 707 of the apparatus 700. Details of the operation of these modules are found throughout this disclosure, including in the description of the flowcharts of FIGS. 3A, 3B, 4, and 5, and in the claims below.

The apparatus 700 and modules 710, 712, 714, 716, 718 disclosed herein may be implemented in hardware or software that is executed on a hardware platform. The hardware or hardware platform may be a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a smart card, a flash memory device (e.g., card, stick, key drive), random access memory (RAM), read only memory (ROM), programmable ROM (PROM), erasable PROM (EPROM), electrically erasable PROM (EEPROM), a general register, or any other suitable non-transitory medium for storing software.

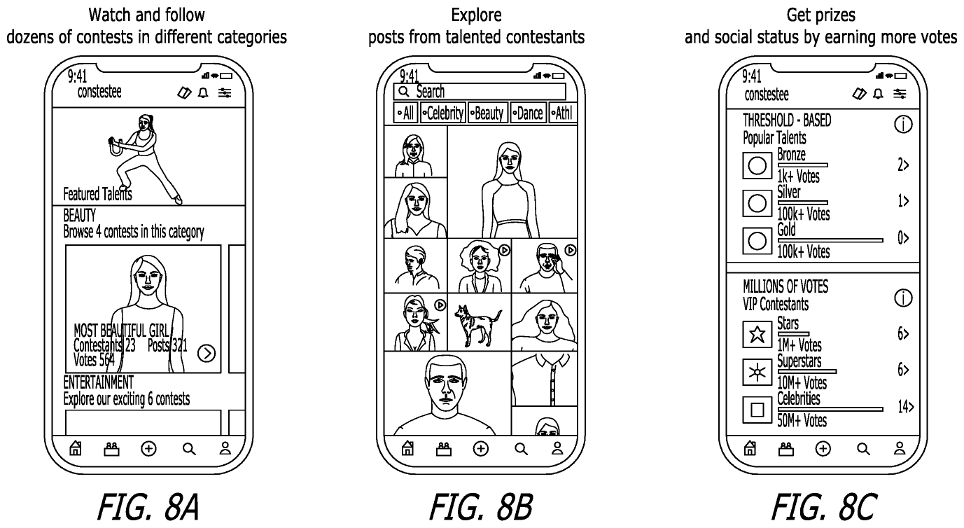

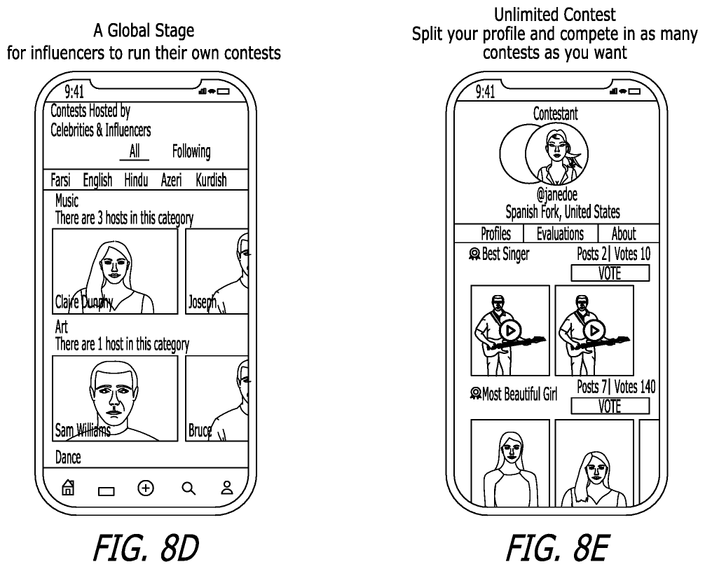

FIGS. 8A-8E are illustrations of user devices displaying various pages of the contest system application. Following are features and benefits of the contest system specific to each type of participant: contestant, voter, host, and sponsor.

Contestant: 1) no formalities—anyone, anytime , anywhere—simple video upload; 2) social status—contestant, popular, VIP talent (bronze, silver, gold, star, superstar, celebrity); 3) global visibility—not by name, location or channel—job opportunity, fame; 4) prize & financial gain; 5) multi-profile—participate in several contests at the same time; 6) overnight fame—seen in a global stage by contest voters (not person)—categorized global stage; 7) never ending contest—unlimited chance to win; 8) global crowd judgment not juries, politics-free, bias-free; 9) archived in directory.

Voter: 1) reward for screen-time (never seen before feature); 2) social status visibility—BSG; 3) voting power—1, 3, 5, 10; 4) filter-based content—based on interest contest & country; 5) quality contents—from talents; 6) meaningful vote(judge to impact), vs. meaningless like—his opinion matters; 7) epic meaning—part of big thing

Host/Influencer: 1) can monetize his fame; 2) steady income (charge enrollment fee, billboard, sponsor, advisor fee, loyalty)—YouTube view fee; 3) being pioneer—sooner than others; 4) no work—delegated to admin & fame monetization; 5) rebirth—rebranding; 6) footprint—influence & contribute to find talents; 7) international exposure.

Host/Company: 1) idea discovery; 2) collaboration; 3) talent discovery

Sponsor: 1) advertise for target & niche; 2) branding & marketing; 3) easy-to-find talent for business use.

The various aspects of this disclosure are provided to enable one of ordinary skill in the art to practice the present invention. Various modifications to exemplary embodiments presented throughout this disclosure will be readily apparent to those skilled in the art. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method of an online contest by a contest system, the method comprising:
enabling creation of a contest entry through a user device, the contest entry including a contest content and associated information comprising one or more specified contests for entry of the contest entry;
receiving the contest entry;
entering the contest entry in at least one contest based on the one or more specified contests; and
enabling access to the contest content by each of a plurality of user devices.

2. The method of claim 1, wherein entering the contest entry in at least one contest based on the one or more specified contests comprises, for each of the one or more specified contests associated with the contest entry:
determining a total number of contest entries having the specified contest associated therewith;
comparing the total number to a respective threshold for the specified contest;
in response to the respective threshold being satisfied, entering the contest entry in the specified contest; and
in response to the respective threshold not being satisfied, entering the contest entry in a generic contest of the specified contest.

3. The method of claim 2, further comprising, for each generic contest in which the contest entry is entered:
monitoring the total number of contest entries received by the contest system that have the specified contest associated therewith;
comparing the total number to the respective threshold for the specified contest; and
in response to the respective threshold being satisfied, initiating the specified contest among the contest entry and each of the other contest entries having the specified contest associated therewith.

4. The method of claim 1, further comprising, prior to entering the contest entry in the one or more specified contests, evaluating the contest entry to determine an accuracy of the associated information.

5. The method of claim 1, wherein enabling access to the contest content by each of a plurality of client devices comprises making the contest content available for playing to a user device.

6. The method of claim 1, further comprising receiving and counting votes cast for the contest entry by members of the contest system.

7. The method of claim 6, further comprising associating a status level with the contest entry based on a count of votes received for the contest entry.

8. The method of claim 7, further comprising:
monitoring the status level of the contest entry and the status level of each of the contest entries in the specified contest; and
initiating a status-level contest separate from the specified contest, the status-level contest being among the contest entries having the same status level associated therewith.

9. An apparatus of a contest system, the apparatus comprising:
a memory; and
a processor coupled to the memory, and operating in accordance with application instructions stored in a computer-readable medium, the processor configured to:
enable creation of a contest entry through a user device, the contest entry including a contest content and associated information comprising one or more specified contests for entry of the contest entry;
receive the contest entry;
enter the contest entry in at least one contest based on the one or more specified contests; and
enable access to the contest content by each of a plurality of user devices.

10. The apparatus of claim 9, wherein the processor enters the contest entry in at least one contest based on the one or more specified contests, by being further configured to, for each of the one or more specified contests associated with the contest entry:
determine a total number of contest entries having the specified contest associated therewith;
compare the total number to a respective threshold for the specified contest;
in response to the respective threshold being satisfied, enter the contest entry in the specified contest; and
in response to the respective threshold not being satisfied, enter the contest entry in a generic contest of the specified contest.

11. The apparatus of claim 10, wherein the processor is further configured to, for each generic contest in which the contest entry is entered:
monitor the total number of contest entries received by the contest system that have the specified contest associated therewith;
compare the total number to the respective threshold for the specified contest; and
in response to the respective threshold being satisfied, initiate the specified contest among the contest entry and each of the other contest entries having the specified contest associated therewith.

12. The apparatus of claim 9, wherein the processor is further configured to, prior to entering the contest entry in the one or more specified contests, evaluate the contest entry to determine an accuracy of the associated information.

13. The apparatus of claim 9, wherein to enable access to the contest content by each of a plurality of client devices, the processor is further configured to make the contest content available for playing to a user device.

14. The apparatus of claim 9, wherein the processor is further configured to receive and count votes cast for the contest entry by members of the contest system.

15. The apparatus of claim 14, wherein the processor is further configured to associate a status level with the contest entry based on a count of votes received for the contest entry.

16. The apparatus of claim 15, wherein the processor is further configured to:
monitor the status level of the contest entry and the status level of each of the contest entries in the specified contest; and
initiate a status-level contest separate from the specified contest, the status-level contest being among the contest entries having the same status level associated therewith.

17. The apparatus of claim 9, wherein the associated information further comprises at least one of: one or more characterizations of a type of contest content, and one or more languages of the contest content.

18. A method of an online contest by a contest system, the method comprising:
enabling creation of a plurality of contest entries for entry into at least one contest, each of the plurality of contest entries including a contest content and associated information comprising one or more specified contests to be entered; and
for each of the one or more specified contests:
determining a total number of contests entries having the specified contest associated therewith;
comparing the total number to a respective threshold for the specified contest; and
in response to the respective threshold not being satisfied, entering each of the contest entries in a generic contest of the specified contest.

19. The method of claim 18, further comprising, for each generic contest and its respective contest entries:
monitoring the total number of contest entries having the specified contest associated therewith;
comparing the number to the respective threshold for the specified contest; and
in response to the respective threshold being satisfied, initiating the specified contest among the contest entry and each of the other contest entries having the specified contest associated therewith.

20. The method of claim 19, further comprising keeping the contest entry in the generic contest.

21. An apparatus of a contest system, the apparatus comprising:
a memory; and
a processor coupled to the memory, and operating in accordance with application instructions stored in a computer-readable medium, the processor configured to:
enable creation of a plurality of contest entries for entry into at least one contest, each of the plurality of contest entries including a contest content and associated information comprising one or more specified contests to be entered;
for each of the one or more specified contests:
determine a total number of contests entries having the specified contest associated therewith;
compare the total number to a respective threshold for the specified contest; and
in response to the respective threshold not being satisfied, enter each of the contest entries in a generic contest of the specified contest.

22. The apparatus of claim 21, wherein the processor is further configured to, for each generic contest and its respective contest entries:
monitor the total number of contest entries having the specified contest associated therewith;
compare the number to the respective threshold for the specified contest; and
in response to the respective threshold being satisfied, initiate the specified contest among the contest entry and each of the other contest entries having the specified contest associated therewith.

23. The apparatus of claim 22, wherein the processor is further configured to keep the contest entry in the generic contest.

24. A method of an online contest by a contest system, the method comprising:
monitoring member activity of a member of the contest system; and
assigning at least one of a voter status and a contestant status to the member based on member activity.

25. The method of claim 24 wherein assigning voter status comprises:
comparing a total number of votes cast by the member against a plurality of threshold numbers; and
determining the voter status of the member based on a comparison outcome.

26. The method of claim 25, further comprising granting one or more voting tickets to the member based on member activity.

27. The method of claim 26, further comprising assigning a number of votes per voting ticket based on the voter status of the member.

28. The method of claim 24, wherein assigning contestant status comprises:
comparing a total number of votes received by the member against a plurality of threshold numbers; and
determining the contestant status of the member based on a comparison outcome.

29. An apparatus of a contest system, the apparatus comprising:
a memory; and
a processor coupled to the memory, and operating in accordance with application instructions stored in a computer-readable medium, the processor configured to:
monitor member activity of a member of the contest system; and
assign at least one of a voter status and a contestant status to the member based on member activity.

30. The apparatus of claim 29 wherein the processor assigns voter status by being further configured to:
compare a total number of votes cast by the member against a plurality of threshold numbers; and
determine the voter status of the member based on a comparison outcome.

31. The apparatus of claim 30, wherein the processor is further configured to grant one or more voting tickets to the member based on member activity.

32. The apparatus of claim 31, wherein the processor is further configured to assign a number of votes per voting ticket based on the voter status of the member.

33. The apparatus of claim 31, wherein member activity corresponds to one or more of: playing of sponsor ads, playing of contest entries, purchasing of voting tickets, previous votes cast, contest participation history, and referral by another member.

34. The apparatus of claim 29, wherein the processor assigns contestant status by being further configured to:
compare a total number of votes received by the member against a plurality of threshold numbers; and
determine the contestant status of the member based on a comparison outcome.

35. A method of an online multi-round contest by a contest system, the method comprising:
a) enabling creation of a contest entry through a user device logged into the contest system under credentials of a contestant member of the contest system, the contest entry including a contest content for a hosted contest;
b) receiving the contest entry;
c) entering the contest entry in the hosted contest;
d) enabling access to the contest content by each of a plurality of user devices, each user device logged into the contest system under the credentials of a member of the contest system;
e) counting votes cast for the contest entry;
f) in response to the votes cast for the contest entry meeting a threshold, determining if an additional round of the multi-round contest is pending;
g) in response to determining an additional round of the multi-round contest is pending, enabling creation of an additional contest entry through a user device logged into the contest system under the credentials of the contestant member;
h) receiving the additional contest entry; and
i) repeating steps d) through h) for the additional contest entry until it is determined at step h) that an additional round of the multi-round contest is not pending.

36. The method of claim 35, further comprising, prior to step c):
i) submitting the contest entry for audition access by at least one user device logged into the contest system under the credentials of a talent evaluator; and
ii) in response to the contest entry passing the audition, proceeding with step c).

37. An apparatus of a contest system, the apparatus comprising:
a memory; and
a processor coupled to the memory, and operating in accordance with application instructions stored in a computer-readable medium, the processor configured to:
a) enable creation of a contest entry through a user device logged into the contest system under credentials of a contestant member of the contest system, the contest entry including a contest content for a hosted contest;
b) receive the contest entry;
c) enter the contest entry in the hosted contest;
d) enable access to the contest content by each of a plurality of user devices, each user device logged into the contest system under the credentials of a member of the contest system;
e) count votes cast for the contest entry;
f) in response to the votes cast for the contest entry meeting a threshold, determine if an additional round of a multi-round contest is pending;
g) in response to determining an additional round of the multi-round contest is pending, enable creation of an additional contest entry through a user device logged into the contest system under the credentials of the contestant member;
h) receive the additional contest entry; and
i) repeat steps d) through h) for the additional contest entry until it is determined at step h) that an additional round of the multi-round contest is not pending.

38. The apparatus of claim 37, wherein the processor is further configured to, prior to step c):
i) submit the contest entry for audition access by at least one user device logged into the contest system under the credentials of a talent evaluator; and
ii) in response to the contest entry passing the audition, proceed with step c).
